(19) United States
(12) Patent Application Publication
(10) Pub. No.: US 2008/0298082 A1
(43) Pub. Date: Dec. 4, 2008

(54) BATH DEVICE WITH CONTROL HAVING BACKLIT BEZEL

(76) Inventor: Lisa Plunk Churchwell, Adamsville, TN (US)

Correspondence Address: CARLSON, GASKEY & OLDS, P.C., 400 WEST MAPLE ROAD, SUITE 350, BIRMINGHAM, MI, 48009, US

(21) Appl. No.: 11/755,762

(22) Filed: May 31, 2007

(51) Int. Cl. F21V 7/04

(52) U.S. Cl. 362/602

(57) ABSTRACT

A whirlpool is provided with a control panel that includes a number of user input devices and at least one display all of which are received in a bezel. The bezel is backlit over at least a majority of its surface area to make the user control panel more readily identifiable and usable.

### BACKGROUND OF THE INVENTION

This application relates to a bathing device, such as a whirlpool bath, wherein a control is provided with a backlit bezel to better highlight the control options to a user.

Whirlpool baths are known, and are becoming increasingly sophisticated. As an example, a number of options and controls are typically provided with the whirlpool bath. Thus, a user can program the whirlpool to run for a predetermined period of time, and can program various features such as temperature, intensity of jets, etc. All of this is known in the art. Also, whirlpools are often provided with controls for an audio system.

In the prior art, control panels have sometimes been highlighted, such as one known control panel that is backlit across the entire panel. However, this known prior art control panel might provide too much light.

Various materials for forming backlit panels are known. However, these backlit panels have not been applied into the whirlpool environment.

### SUMMARY OF THE INVENTION

In a disclosed embodiment of this invention, a whirlpool is provided with a control panel having a backlit bezel around the outer periphery of the control panel. The backlit bezel highlights the location of the various control input devices, such as buttons, etc. In one disclosed embodiment, the backlit bezel is formed of a material wherein the bezel itself is formed of fiber optic elements which provide the backlighting. Other ways of providing backlighting, such as LEDs, etc., may also be used.

These and other features of the present invention can be best understood from the following specification and drawings, the following of which is a brief description.

### BRIEF DESCRIPTION OF THE DRAWINGS

FIG. 1 is a perspective view of a whirlpool.

FIG. 2 is a front view of a control panel according to the present invention.

FIG. 3 shows a first type of bezel material which may be utilized in this application.

FIG. 4 shows a second type of bezel material.

FIG. 5 shows an overall panel construction for forming the inventive bezel.

### DETAILED DESCRIPTION OF THE PREFERRED EMBODIMENT

A whirlpool 20 is shown in FIG. 1, and incorporates jets 22 and 24 for providing jets of water into a tub 25. Inlets 26 take water in, and direct the water outwardly through the jets, as known.

A control panel 28 is shown in the whirlpool. As known, the control panel 28 may allow the user to adjust the time of the whirlpool operation, temperature, intensity of jets, etc. In addition, the control panel 28 could also provide control over an audio device such as a sound system, associated with the whirlpool.

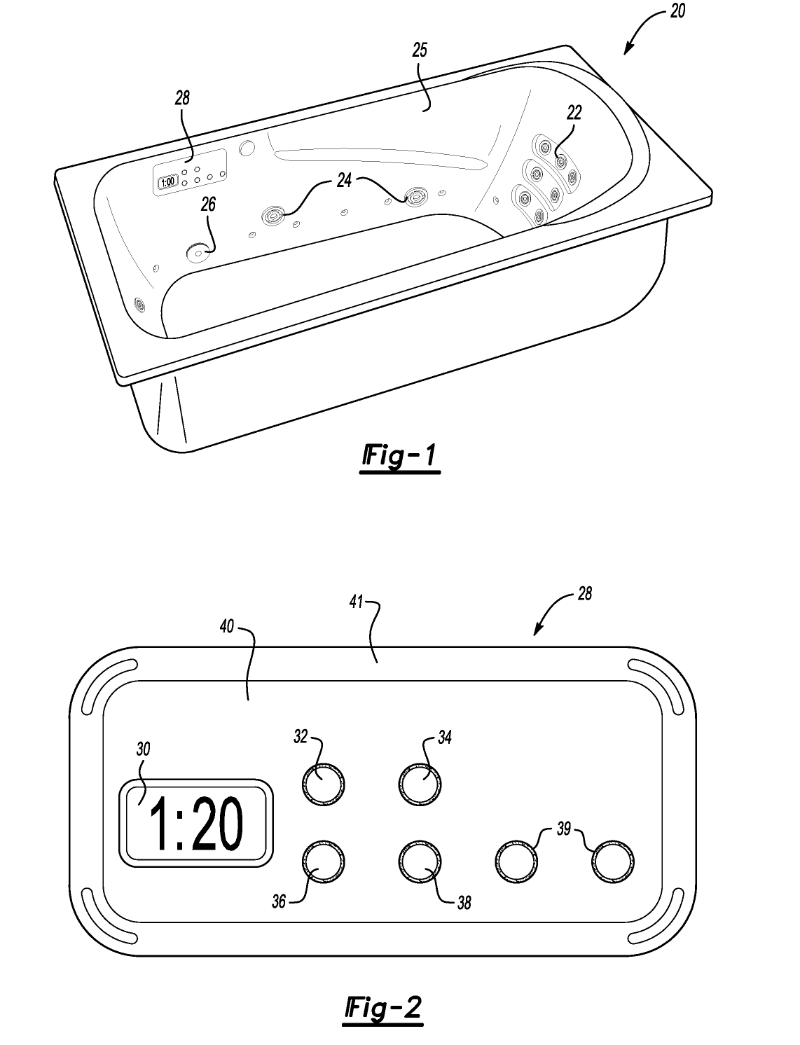

As shown in FIG. 2, the control panel 28 has various display features such as a time display 30, and may also display temperature. Various buttons 30, 32, 36, and 38 allow one to control air mixing, and various other options. In addition, buttons 39 may allow control of an audio system. The buttons are shown somewhat schematically, and may themselves be any type of input device.

The bezel 41 of the FIG. 2 control panel 28 is formed to be backlit across the periphery of the surface area 40 of the panel 28. In a disclosed embodiment, the entire periphery is backlit. The backlit bezel highlights the location of the various input devices, and allows a user to more easily see and locate the location of the input devices.

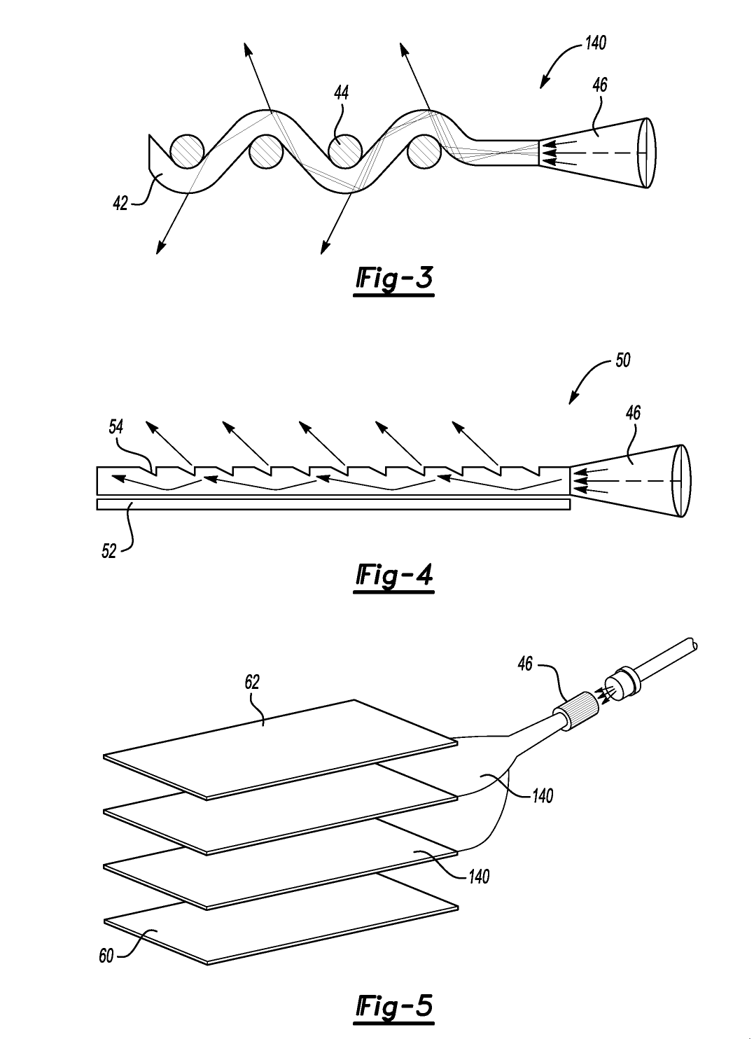

As shown in FIG. 3, in one embodiment, the bezel 140 may be formed from optical fibers 42 interwoven with fill threads 44. An input 46 directs light into the optical fibers.

Another embodiment 50 is shown in FIG. 4. In embodiment 50, optical fibers 52 are provided with a cladding having abrasions 54 to allow light to exit.

FIG. 5 shows an arrangement wherein there are a plurality of panels such as the panel 140 in FIG. 3 arranged together. A diffuser layer 62 and a Mylar reflector layer 60 may also be included in the overall panel.

The elements shown in FIGS. 3-5 are generally known and available from a company known as Lumitex Illumination Technology. Their products may be found at www.lumitex.com.

Various other methods of backlighting the bezel may be utilized. As one example, LEDs may be backlight the bezel.

The present invention thus provides a more easily utilized control panel for a whirlpool. The invention has been disclosed in one embodiment, however, a worker of ordinary skill in the art would recognizer that certain modifications would come within the scope of this invention. For that reason, the following claims should be studied to determine the true scope and content of this invention.

What is claimed is:

1. A whirlpool including:
a control panel receiving a plurality of user input devices;
said plurality of user input devices being received on a control panel with a bezel around its periphery; and
said bezel being provided with a backlighting over a majority of its surface area.

2. The whirlpool as set forth in claim 1, wherein said bezel is backlit over the entirety of the periphery of the control panel.

3. The whirlpool as set forth in claim 1, wherein a display is provided to display time and temperature.

4. The whirlpool as set forth in claim 1, wherein said user input devices include devices to control an audio system.

5. The whirlpool as set forth in claim 1, wherein said bezel is formed of optical fibers that provide the backlighting.
